(19) United States
(12) Patent Application Publication
(10) Pub. No.: US 2008/0120480 A1
(43) Pub. Date: May 22, 2008

(54) Method and System For Preserving Critical Storage Contents Across A System Restart

(75) Inventors: Robert O. Dryfoos, Hopewell Junction, NY (US); Kenneth H. Warner, Brookfield, CT (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/562,452

(22) Filed: Nov. 22, 2006

(51) Int. Cl. G06F 12/16; G06F 12/08

(52) U.S. Cl. 711/161; 711/E12.103

(57) ABSTRACT

Disclosed are a method and system for a computer operating system to allocate “recoverable” memory for a table. The invention involves updating storage allocation APIs to specify a request for “recoverable” storage and for the operating system's saving of virtual and real storage address information about the “recoverable” storage allocation. On a subsequent system restart, when the recoverable storage allocation is again requested, the operating system will use the saved information to rebuild the required virtual address space mappings (virtual addresses to backing real storage) to reallocate the same virtual and real storage. The operating system must also track requests for memory, which is not deemed “recoverable”, and avoid allocating virtual and real storage addresses, which are being used for “recoverable” storage requests.

### BACKGROUND OF THE INVENTION

1. Field of the Invention

This invention generally relates to memory management in a computer system, and more specifically, to preserving critical storage contents across a system restart.

2. Background Art

In a typical computer system, tables that reside in memory may hold some critical contents that need to be preserved across a system restart (provided that memory is not cleared as part of the restart). If such a table is small, infrequently updated, and its contents do not include memory addresses (such as table chain pointers), it can be reasonable to simply file out the table contents periodically. During system restart, the filed out table can be copied to whatever memory gets allocated for the table. If the table does contain memory addresses, then the table either needs to be copied into the same memory locations or, if possible, the memory addresses in the table need to be updated based on the table's new location in memory. In all of these cases where the table is filed out, it is possible that the file copy may not match the table contents in memory at the time when a system restart is performed.

Another possible solution is provided by having the operating system map virtual addresses to the same real storage on each system restart. Additional code is then written to verify that the table still resides at the same virtual addresses (and therefore at the same real storage addresses). If the table address in memory is different, then the table contents have been lost and table initialization is required.

### SUMMARY OF THE INVENTION

An object of this invention is to preserve critical storage contents, in a computer system, across a system restart.

Another object of the present invention is to preserve virtual addresses and their corresponding storage contents for critical system tables across a system restart.

A further object of the invention is to update storage allocation APIs to specify a request for specified recoverable storage and to use an operating system to save virtual and real storage address information about that specified recoverable storage allocation.

These and other objectives are attained with a method and system for a computer operating system to allocate “recoverable” memory for a table. The invention involves updating storage allocation APIs to specify a request for “recoverable” storage and for the operating system's saving of virtual and real storage address information about the “recoverable” storage allocation. On a subsequent system restart, when the recoverable storage allocation is again requested, the operating system will use the saved information to rebuild the required virtual address space mappings (virtual addresses to backing real storage) to reallocate the same virtual and real storage. The operating system preferably also tracks requests for memory, which is not deemed “recoverable”, and avoids allocating virtual and real storage addresses, which are being used for “recoverable” storage requests.

The preferred embodiment of the invention, described below in detail, provides a number of important advantages. These include:
1. Reusing the same virtual and real storage for the allocation avoids the possibility for “lost updates” that is present in solutions, which attempt to preserve the table's storage contents by periodically filing it out and then copying it to storage during a system restart.
2. Reusing the same virtual and real storage for the allocation avoids the potential requirement for updating table storage contents such as storage chain pointers if and when the table is relocated to a different memory location on a system restart.
3. The reconstruction of virtual storage mappings is more efficient than reading from file and copying into a new storage allocation (which will also require construction of virtual storage mappings) and enables the system restart to complete faster.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a computer system block diagram.

FIG. 2 shows a service call used in the preferred embodiment of the invention to request specified recoverable storage.

FIG. 3 outlines the form of a Storage Recovery Table that may be used in the implementation of this invention.

FIG. 4 illustrates the form of a System Storage Allocation Table that is preferably used in the practice of the present invention.

FIG. 5 shows a routine that may be used to allocate storage for non-recoverable requests and “new” recoverable requests.

### DETAILED DESCRIPTION OF THE PREFERRED EMBODIMENTS

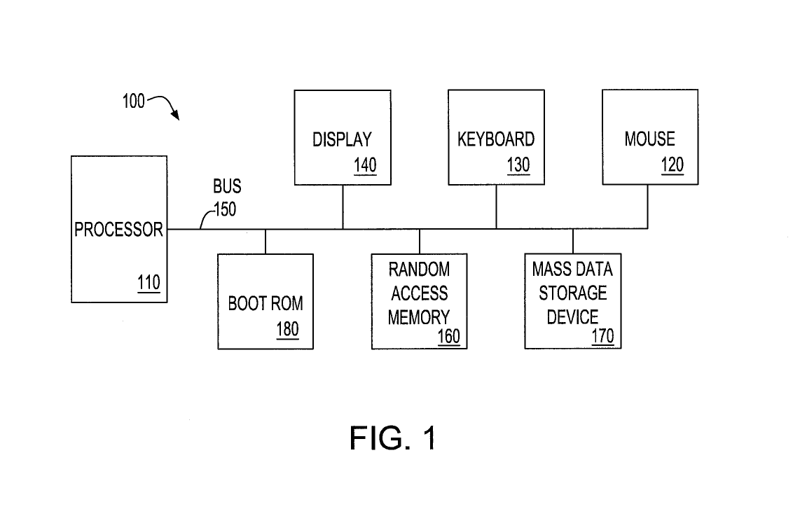

FIG. 1 illustrates a basic microprocessor-based computer system architecture. The computer system 100 includes processor 110. Input devices such as mouse 120 and keyboard 130 permit the user to input data to computer system 100. Information generated by the processor is provided to an output device such as display 140. Computer system 100 generally includes random access memory (RAM) 160, which is used by the processor. Mass data storage device 170 is used to retain programs and data even when the computer system is powered down. For example, mass storage device 170 may be an electromechanical hard drive or a solid-state disk drive. Mouse 120, keyboard 130, RAM 160, boot ROM 180, and mass storage device 170 are typically communicatively coupled to processor 110 through one or more address and data busses such as bus 150.

Initialization of the computer system is performed upon power-up of the computer system or hardware or software reset operations. In one boot scheme, the processor is designed to read a pre-determined memory location when the processor is reset or powered up. The pre-determined memory location stores a pointer or an address, which directs the processor to a memory address of the beginning of the bootstrap routines. The pointer or address is referred to as a boot vector.

As indicated above, for system critical tables that reside in memory, there can be a need to preserve table contents across a system restart. The present invention addresses this need by preserving virtual addresses and their corresponding storage contents for critical system tables across a system restart.

In computer systems, it is customary that there be one-to-one correspondence between the memory address produced by the processor and a specific area in the physical memory of the system. It is an error for the processor to request access to an address, which does not have an associated physical memory area. This limits the operating system and applications to an address space determined by the actual physical memory installed in the system. Modern computer systems have overcome this limitation through the use of virtual memory, which implements a translation table (TT) to map program (virtual) addresses to real memory addresses.

With virtual memory, the program works in an address space limited only by the processor architecture. It is a function of the operating system to ensure that the data and code a program is currently using is in main memory and that the translation table can map the virtual address to the real address correctly. In a virtual memory system, the allocation of memory is most commonly performed by the operating system software.

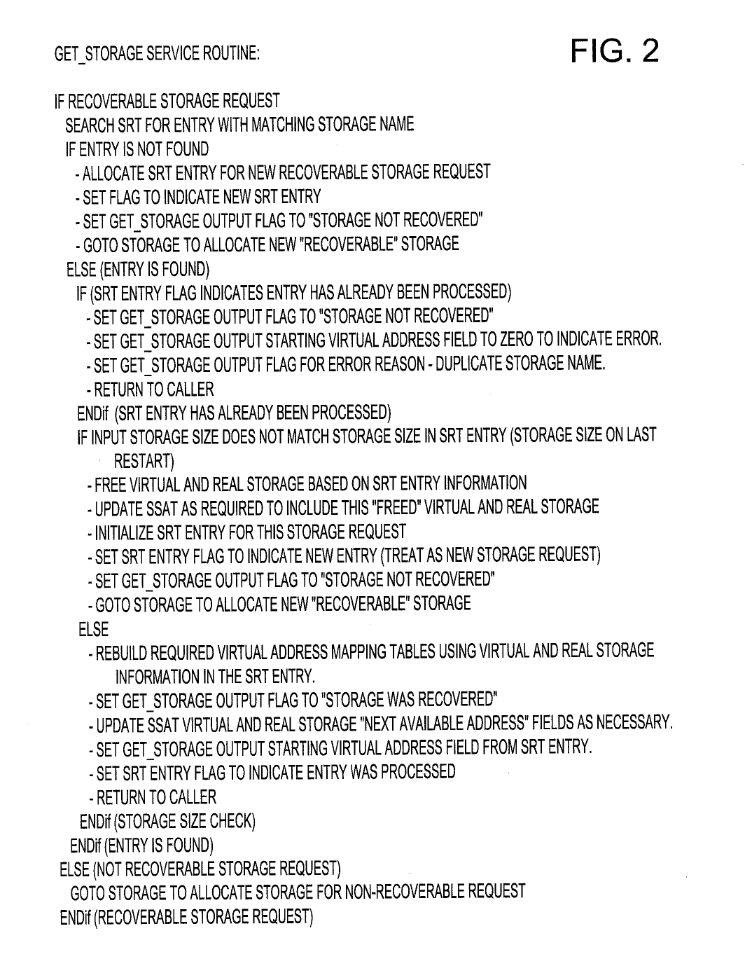

In accordance with the preferred embodiment of this invention, when an operating system is first started, storage is allocated for various system tables. In order to preserve this storage on subsequent system restarts, the operating system provides a system service call (assembler macro, C/C++ function, etc.), which can be used to request “recoverable” storage. The preferred “get_storage” service, as shown in FIG. 2, provides for the following input and output parameters:

Size of the storage allocation request (input from caller);

Unique name or tag to associate with the storage request (input from caller);

Recoverable/non-recoverable storage flag (input from caller);

Starting virtual storage address (output returned to caller); and

Success/failure flag on recovering requested storage (output returned to caller).

The get_storage service routine of FIG. 2 also includes the following:
i) get_storage interface: an output flag byte to indicate error reason code (if get_storage fails, output address is set to zero and flag byte indicates failure reason);
ii) SRT entry: a flag bit which indicates that entry has been processed and storage has been allocated (allows for detection of attempt to use of a storage name on more than one get_storage request for recoverable storage).

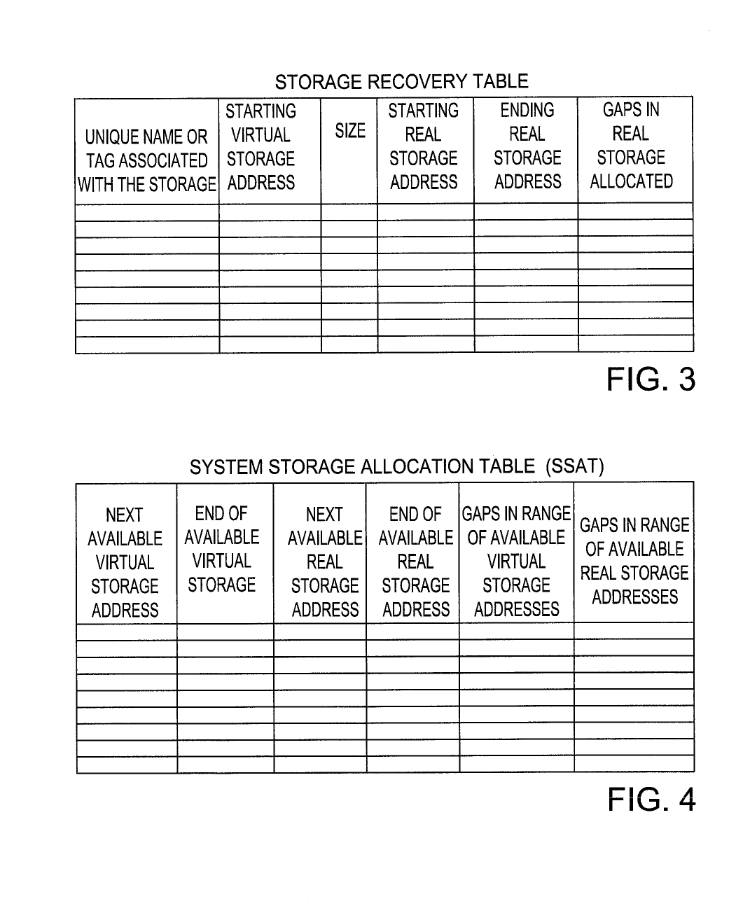

In order to recover storage allocations on subsequent system restarts, a “storage recovery” table (SRT) is needed to hold information on each recoverable storage allocation. An example SRT is represented in FIG. 3. Each SRT entry holds enough information to reconstruct the virtual to real storage mappings for the storage allocation. Each SRT entry holds the following information on a single recoverable storage allocation:

Unique name or tag associated with the storage;

Starting virtual storage address;

Size of the storage allocation;

Starting real storage address;

Ending real storage address; and

Gaps in real storage allocated.

The SRT is kept in real storage and it is not mapped in the virtual address space being constructed by the operating system. This is done to limit the possibility of SRT storage corruption. The real storage address of the SRT is kept on file and is retrieved from file by the operating system during the initial phase of a system restart.

In addition, a “system storage allocation” table (SSAT) is used, during system restart, to hold information on current virtual and real storage resources available for storage allocation request (both recoverable and non-recoverable storage). An example of an SSAT is shown in FIG. 4, and this table information includes:

Next available virtual storage address;

End of available virtual storage;

Next available real storage address;

End of available real storage address;

Gaps in range of available virtual storage addresses; and

Gaps in range of available real storage addresses.

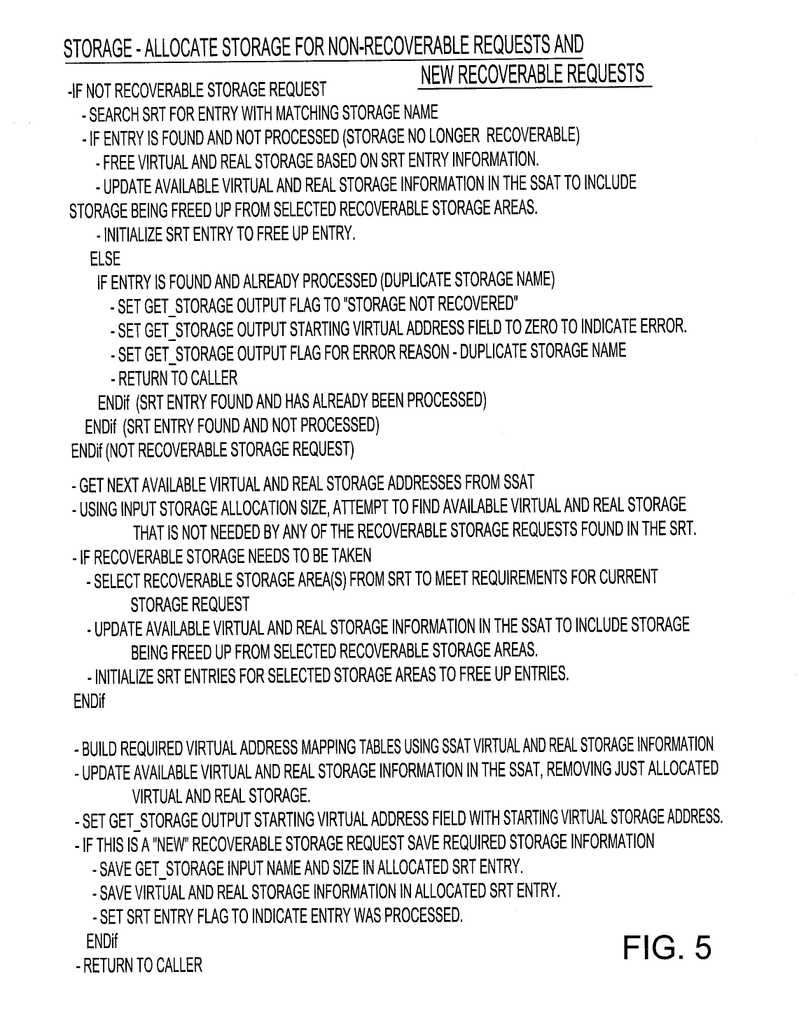

FIG. 5 shows a routine for allocating storage for non-recoverable requests and “new” recoverable requests. When a call is made to invoke this routine, the next available virtual and real storage addresses are obtained from the SSAT; and using information from the SSAT, the routine attempts to find available virtual and real storage that is not needed by any recoverable storage requests. If recoverable storage needs to be taken, the routine selects recoverable storage area(s) from the SRT, the virtual and real storage information in the SSAT is updated, and the SRT entries for the selected storage areas are updated.

A virtual address mapping is built using virtual and real storage information in the SSAT, virtual and real storage information are updated in the SSAT, and the starting virtual storage address is set up in the caller's output area. If this is a new recoverable storage request, the required storage information is saved. In particular, the storage name and size, and the virtual and real storage information are saved in the SRT entry.

The present invention, in its preferred embodiment, provides several important advantages. Among these are:
1. Reusing the same virtual and real storage for the allocation avoids the possibility for “lost updates” that is present in solutions which attempt to preserve the table's storage contents by periodically filing it out and then copying it to storage during a system restart.
2. Reusing the same virtual and real storage for the allocation avoids the potential requirement for updating table storage contents such as storage chain pointers if and when the table is relocated to a different memory location on a system restart.
3. The reconstruction of virtual storage mappings is more efficient than reading from file and copying into a new storage allocation (which will also require construction of virtual storage mappings) and enables the system restart to complete faster.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. A method of preserving specified storage contents, in a computer system, across a system restart, said computer system having an operating system and a main memory defining a real memory storage with real memory addresses, and a virtual memory storage with virtual memory addresses, the method comprising the steps of:
saving selected data at specified virtual memory addresses; and
preserving said specified virtual memory addresses, and their corresponding contents, across a restart of the computer system.

2. A method according to claim 1, wherein the preserving step includes the step of providing the operating system with a service call to request the selected data at said specified virtual memory addresses on said restart.

3. A method according to claim 2, wherein the providing step includes the step of providing said system service call with:
i) a size of a storage allocation request;
ii) a unique name or tag to associate with the storage request; and
iii) a recoverable/non-recoverable storage flag.

4. A method according to claim 1, wherein the preserving step includes the step of providing a storage recovery table (SRT) to hold information on each recoverable storage allocation.

5. A method according to claim 4, wherein said SRT includes a plurality of entries, each of said entries including information to reconstruct a virtual to real storage mapping for an associated storage allocation.

6. A method according to claim 1, wherein the preserving step includes the step of using a system storage allocation table (SSAT) during the system restart to hold information on current virtual and real storage resources available for storage allocation requests.

7. A method according to claim 6, wherein the using step includes the step of providing said SSAT with:
i) a next available virtual storage address;
ii) an end of available virtual storage;
iii) a next available real storage address; and
iv) an end of available real storage address.

8. A memory management system for preserving specified storage contents, in a computer system, across a system restart, said computer system having an operating system and a main memory defining a real memory storage with real memory addresses, and a virtual memory storage with virtual memory addresses, the memory management system comprising:
means for saving selected data at specified virtual memory addresses; and
means for preserving said specified virtual memory addresses, and their corresponding contents, across a restart of the computer system.

9. A memory management system according to claim 8, wherein the preserving means includes a system service call to request the selected data at said specified virtual memory addresses on said restart.

10. A memory management system according to claim 9, wherein said system service call includes data identifying:
i) a size of a storage allocation request;
ii) a unique name or tag to associate with the storage request; and
iii) a recoverable/non-recoverable storage flag.

11. A memory management system according to claim 8, wherein the preserving means includes a storage recovery table (SRT) to hold information on each recoverable storage allocation.

12. A memory management system according to claim 11, wherein said SRT includes a plurality of entries, each of said entries including information to reconstruct a virtual to real storage mapping for an associated storage allocation.

13. A memory management system according to claim 12, wherein the preserving means includes a system storage allocation table (SSAT) to hold information, during the system restart, on current virtual and real storage resources available for storage allocation requests.

14. A program storage device readable by machine, tangibly embodying a program of instructions executable by the machine to perform method steps for preserving specified storage contents, in a computer system, across a system restart, said computer system having an operating system and a main memory defining a real memory storage with real memory addresses, and a virtual memory storage with virtual memory addresses, said method steps comprising of:
saving selected data at specified virtual memory addresses; and
preserving said specified virtual memory addresses, and their corresponding contents, across a restart of the computer system.

15. A program storage device according to claim 14, wherein the preserving step includes the step of providing the operating system with a service call to request the selected data at said specified virtual memory addresses on said restart including the step of providing said system service call with:
i) a size of a storage allocation request;
ii) a unique name or tag to associate with the storage request; and
iii) a recoverable/non-recoverable storage flag.

16. A program storage device according to claim 14, wherein the preserving step includes the step of providing a storage recovery table (SRT) to hold information on each recoverable storage allocation, wherein said SRT includes a plurality of entries, each of said entries including information to reconstruct a virtual to real storage mapping for an associated storage allocation.

17. A program storage device according to claim 14, wherein the preserving step includes the step of using a system storage allocation table (SSAT) during the system restart to hold information on current virtual and real storage resources available for storage allocation requests.

18. A program storage device according to claim 17, wherein the using step includes the step of providing said SSAT with:
i) a next available virtual storage address;
ii) an end of available virtual storage;
iii) a next available real storage address; and
iv) an end of available real storage address.
